(19) United States
(12) Patent Application Publication
(10) Pub. No.: US 2024/0286153 A1
(43) Pub. Date: Aug. 29, 2024

(54) SPRAY DEVICE AND COATING METHOD

(71) Applicants: TOYOTA JIDOSHA KABUSHIKI KAISHA, Toyota-shi (JP); CARLISLE FLUID TECHNOLOGIES RANSBURG JAPAN KK, Yokohama (JP)

(72) Inventors: Kazuki TANAKA, Toyota-shi (JP); Tsuyoshi YAMAGUCHI, Toyota-shi (JP); Shigefumi HASHIMOTO, Yokohama-shi (JP); Shokichi ISHIBASHI, Toyota-shi (JP)

(73) Assignees: TOYOTA JIDOSHA KABUSHIKI KAISHA, Toyota-shi (JP); CARLISLE FLUID TECHNOLOGIES RANSBURG JAPAN KK, Yokohama (JP)

(21) Appl. No.: 18/582,842

(22) Filed: Feb. 21, 2024

(30) Foreign Application Priority Data
Feb. 27, 2023 (JP) 2023-028273

(51) Int. Cl. B05B 5/04; B05B 5/03

(52) U.S. Cl. CPC B05B 5/0426; B05B 5/03

(57) ABSTRACT

A spray device that atomizes and applies coating material to a coating target object includes a tip portion provided with a coating material supply port to supply coating material, an atomizing air supply port to supply air designed to atomize the supplied coating material, a plurality of pattern air supply ports to supply pattern air designed to adjust a spray width of the supplied coating material onto the coating target object, and first twisted supply paths to each of the pattern air supply ports, and a shielding plate that is provided adjacent to the outside of the pattern air supply ports and protrudes from a lower surface of the spray device toward the coating target object to prevent inflow of air outside an outer wall of the spray device.

### CROSS-REFERENCE TO RELATED APPLICATION

This application claims priority to Japanese Patent Application No. 2023-028273 filed on Feb. 27, 2023, incorporated herein by reference in its entirety.

### BACKGROUND

### 1. Technical Field

The present disclosure relates to a spray device that atomizes coating material and applies same to a coating target object, and a coating method using the spray device, and more particularly to a spray device that improves coating efficiency by suppressing direct air supply to a coating target object, and a coating method using the spray device.

### 2. Description of Related Art

Air guns for coating are cheaper than bell-type coating machines and are widely used. The air gun sprays coating material onto a coating target object using two systems: atomizing air that atomizes the coating material and pattern air for determining a target range to the coating target object.

### SUMMARY

However, in the case of non-electrostatic coating, the air gun for coating has a low coating efficiency, since the amount of coating material adhered to the coating target object is as low as about 40%. Also, with air guns, the electrostatic effect, which enhances efficiency through electric attraction, is miniscule, so there are many obstacles to increasing coating efficiency.

The present disclosure provides a spray device and the like that can improve coating efficiency by suppressing direct air supply to a coating target object.

A first aspect of the disclosure relates to a spray device that atomizes coating material and applies the atomized coating material to a coating target object, the spray device including,
a tip portion provided with a coating material supply port to supply coating material, an atomizing air supply port to supply air designed to atomize the supplied coating material, a plurality of pattern air supply ports to supply pattern air designed to adjust a spray width of the supplied coating material onto the coating target object, and first twisted supply paths to each of the pattern air supply ports, and
a shielding plate that is provided adjacent to the outside of the pattern air supply ports and protrudes from a lower surface of the tip portion toward the coating target object to prevent an inflow of air outside an outer wall of the spray device.

The atomizing air supply port is provided adjacent to the coating material supply port,
the pattern air supply ports are provided to surround the coating material supply port and the atomizing air supply port, and the first twisted supply path is configured to supply the pattern air obliquely and spirally with respect to a supply direction of the coating material.

In the first aspect, a plurality of second twisted supply paths spaced apart from each other and provided inside the spray device may be configured to spirally supply atomizing air from the atomizing air supply port in the supply direction of the coating material.

In the first aspect, the second twisted supply paths may have a shape twisted obliquely inward from an upper portion of the tip portion.

In the first aspect, a first twist direction of the first twisted supply paths to the pattern air supply ports and a second twist direction of the second twisted supply paths to the atomizing air supply port may be directed to the same direction.

In the first aspect, the tip portion may include a wide path which is connected to the second twisted supply paths and is wider than the second twisted supply path.

In the first aspect, the atomizing air supply port may be provided to surround the coating material supply port and have a circular ring shape.

In the first aspect, the tip portion may include a coating material supply path to supply the coating material, the coating material supply path being connected to the coating material supply port. The tip portion may include a straight path that is connected to the wide path, extends in an axial direction of the coating material supply path, and has an annular cylindrical shape.

In the first aspect, the tip portion may include a wide path that is wider than the first twisted supply path, extends from the upper portion of the tip portion in an axial direction of the coating material supply path, and is connected to the first twisted supply path.

In the first aspect, the first twisted supply path may be spirally formed towards a central axis of the tip portion.

In the first aspect, the pattern air supply port may have an elliptical shape.

A second aspect of the disclosure relates to a coating method using the spray device described above.

With each aspect of the present disclosure, it is possible to provide a spray device or the like that improves coating efficiency by suppressing direct air supply to a coating target object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for illustrating a tip portion of a spray device according to a comparative example;

FIG. 2 is a diagram for illustrating a tip portion of a spray device according to an embodiment;

FIG. 3 is an enlarged view of the tip portion of the comparative example illustrated in FIG. 1; and

FIG. 4 is an enlarged view of the tip portion of the spray device according to the embodiment.

### DETAILED DESCRIPTION OF EMBODIMENTS

### First Embodiment

Hereinafter, a specific embodiment to which the present disclosure is applied will be described in detail with reference to the drawings. However, the present disclosure is not limited to the following embodiment. Also, for clarity of explanation, the following description and drawings are simplified as appropriate.

A coating system can be used to apply a resin coating to a coating target object (for example, a bumper and the like). When coating an insulating material such as an insulating resin, by applying a voltage to a conductive jig that holds the coating target object, the electrostatic effect can be used to allow the coating material to adhere to the coating target object. Electrostatic coating is useful because coating efficiency is generally high. Further, this coating system uses a more compact spray device (also called an air gun or a spray gun) instead of a bell-type coating machine having a rotating mechanism. Thus, in this coating system, for example, a plurality of (for example, two, three, or more) spray devices can be arranged side by side, for example water-based coating material and solvent-based coating material can be arranged in separate (that is, two) spray devices. As a result, it is possible to prevent deterioration of coating quality due to mixing of different types of coating materials.

In general electrostatic coating, high voltage is applied to the coating machine side to perform electrostatic coating, but when using water-based coating material, a method of insulating the path of the water-based coating material and providing the coating machine with a coating material tank, or a method of applying a high voltage to the sprayed coating material particles from the outside of the coating machine is used. In either case, additional equipment is required, and it is difficult to use solvent-based coating materials together. On the other hand, in this coating system, which applies voltage to the jig instead of the coating machine, high voltage is not applied to the coating machine side, so the above-described necessary equipment is not necessary and a plurality of small spray devices (air guns and spray guns) can be installed side by side. This makes it possible to electrostatically coat different kinds of coating materials, such as water-based coating materials and solvent-based coating materials, within a single system.

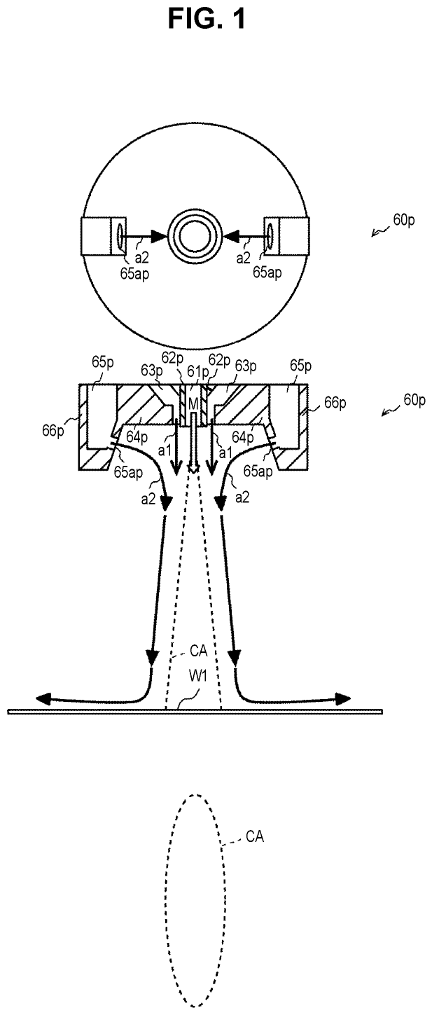

FIG. 1 is a diagram for illustrating a tip portion 60p of a spray device 6p according to a comparative example.

FIG. 1 includes a top view (top) of the tip portion 60p, a side view (middle) of the tip portion 60p and a coating target surface W1, and a top view (bottom) illustrating a coating area CA on the coating target surface W1.

In general, a spray device, also called an air gun, sprays coating material using two systems: atomizing air designed to atomize the coating material and pattern air for determining an area targeted onto the coating target object. Therefore, the air gun requires a large amount of air, and the air is directly hit against the coating target object. As a result, the coating material carried by the air may bounce on the coating target object or may flow outward along the coating target object. Both the amount of the pattern air and the pressure applied to the coating target object increase, and the air becomes dominant, resulting in a decrease in the electrostatic effect and a deterioration of the coating efficiency. Conversely, when the amount of air is reduced, the atomization performance is significantly affected, leading to a deterioration in quality.

As illustrated in FIG. 1, the tip portion 60p of the spray device 6p in the comparative example tends to eject air a1 designed to atomize coating material M and pattern air a2 for diffusing the atomized coating material directly onto the coating target object W. 15

A coating material supply path 61p used to supply the coating material M is provided in the center of the tip portion 60p of the spray device 6p. The coating material M supplied from the coating material supply path 61p is atomized by the atomizing air a1 supplied from an atomizing air supply port 63ap. Further, although the atomized coating material is slightly diffused by the pattern air a2 supplied from the outside toward the center 20 of the tip portion 60p via a pattern air supply path 65p, the coating material is discharged onto the coating target object W with the still large amount of air and high pressure. In this specification, such air may also be referred to as direct air to the coating target object. Therefore, air is more dominant than coating material compared to bell-type coating machines, and the electrostatic effect is reduced, and as a result a lot of bouncing is experienced on the coating target object, and the amount of atomized coating material that flows to both sides of the coating target object is also large, leading to a deterioration in efficiency. Conversely, when the amount of air is reduced, the atomization performance is lowered, and thus the coating quality may deteriorate. Also, as illustrated in the bottom of FIG. 1, the coating area CA on the coating target surface W1 has an elongated elliptical shape, so in order to coat over a wider area, the tip portion 60p of a spray device 6p must be moved in a predetermined direction (left-right direction in FIG. 1). Thus, efficient coating cannot be achieved.

Therefore, as described below, a tip portion 60 of the spray device 6 according to a first embodiment has a mechanism that diffuses air in all directions.

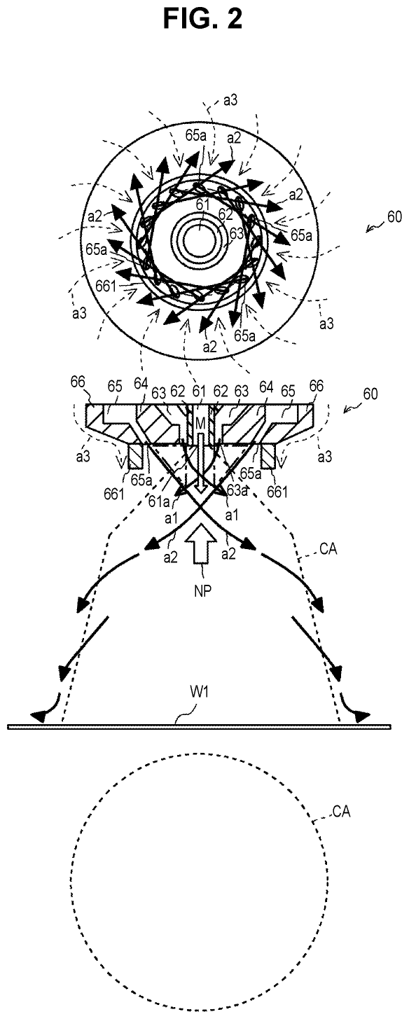

FIG. 2 is a diagram for illustrating the tip portion 60 of the spray device 6 according to the first embodiment.

FIG. 2 includes a top view (top) of the tip portion 60, a side view (middle) of the tip portion 60 and a coating target surface W1, and a top view (bottom) illustrating a coating area CA on the coating target surface W1.

As illustrated in the top of FIG. 2, the tip portion 60 of the spray device 6 is a substantially circular member when viewed from above, but is not limited to this. For example, the shape of the tip portion 60 may be a polygon that approximates a circle. As illustrated in the middle of FIG. 2, at the center of the tip portion 60, a coating material supply pipe 62 having a cylindrical shape is provided that vertically penetrates through the member. A coating material supply path 61 used to supply the coating material M is formed in the coating material supply pipe 62.

An atomizing air supply path 63 is provided adjacent to a coating material supply port 61a. The atomizing air supply path 63 can be provided in a circular ring shape so as to surround the coating material supply port 61a having a circular shape. In some embodiments, an atomizing air supply port 63a may include a plurality of circumferentially spaced holes (not illustrated). Each atomizing air supply path 63 is configured to twist in a coating material supply direction (that is, vertically downward) inside the tip portion 60 so that the atomizing air a1 supplied from each hole of the atomizing air supply port 63a is ejected so as to supply spiral air onto the coating target object W. In some embodiments, the holes of the atomizing air supply port 63a may be evenly spaced around the circumference. The atomizing air supply path 63 can be supplied with atomizing air having a pressure and air volume sufficient to satisfy the atomization performance from an atomizing air supply source (not illustrated).

A pattern air supply port 65a is provided outside the atomizing air supply port 63a. The pattern air supply port 65a is provided in a circular ring shape so as to surround the coating material supply port 61a having a circular shape and the atomizing air supply port 63a having a circular ring shape. As illustrated in the top of FIG. 2, the pattern air supply port 65a includes a plurality of holes (a plurality of pattern air supply ports) arranged on the circumference, and the shape of each hole can be elliptical. Each hole of the atomizing air supply port 63a may be equally spaced on the circumference. Each pattern air supply path 65 is spirally formed so that the supplied pattern air a2 collides obliquely downward (for example, at an acute angle) spirally with the coating material M flowing vertically downward.

A shielding plate 661 protruding downward from a lower surface of the tip portion 60 is provided outside the pattern air supply port 65a. The shielding plate 661 may be formed vertically downward with respect to the lower surface of the tip portion 60 where the coating material supply port 61a, the atomizing air supply port 63a, and the pattern air supply port 65a are formed. The shielding plate 661 is formed in a circular ring shape so as to surround the pattern air supply port 65a having a circular ring shape, but is not limited to this. For example, the shielding plate may have a rectangular ring shape, a polygonal ring shape, or the like. In addition, on the lower surface of the tip portion 60, an outer peripheral edge portion of the shielding plate 661 is tapered.

With such a configuration, air a3 (atmospheric air) outside an outer wall 66 of the tip portion 60 can be prevented from flowing along the outer wall 66 and lower surface of the tip portion 60 to the vicinity of the coating material supply port 61a, the atomizing air supply port 63a, and the pattern air supply port 65a. In addition, this may cause a negative pressure NP directed from the coating target surface W1 to the coating material supply port 61a, as illustrated in FIG. 2. Therefore, direct air in the direction toward the coating target object can be reduced by directing the direction of the atomized air and the pattern air from a direction toward the coating target object to a direction opposite to the coating target object, thus making it easier to obtain the electrostatic effect. As a result, the amount of coating material adhered increases. In addition, by suppressing the direct air directed toward the coating target object, the pattern air a2 supplied obliquely inward from the pattern air supply port 65a can be directed further toward a diffusion direction. The coating area CA on the coating target surface W1 illustrated in the bottom of FIG. 2 is substantially circular, and as a result, compared to the elongated ellipse in the case of FIG. 1, the tip portion 60 of the spray device 6 according to this embodiment can adjust or widen the pattern width thereof and thus coat a wider area. The pattern air supply path 65 may be supplied with pattern air from a pattern air supply source (not illustrated) at pressures and amounts sufficient to satisfy the desired coating quality.

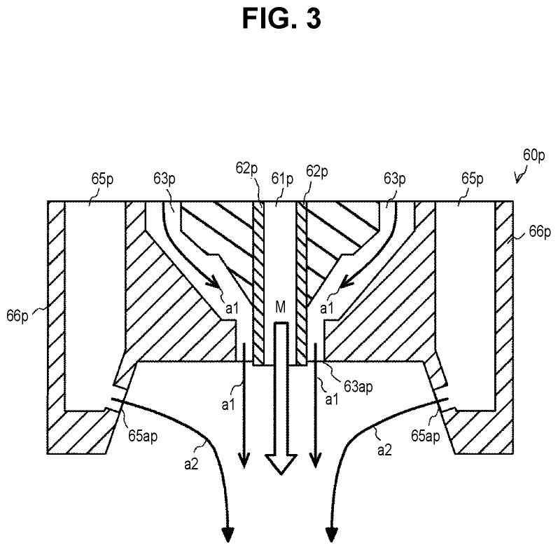

FIG. 3 is an enlarged view of the tip portion of the comparative example of FIG. 1.

In the comparative example, an atomizing air supply path 63p is formed obliquely inward from the upper end portion of the tip portion 60p to the vicinity of the coating material supply pipe 62p, and then vertically downward. The atomizing air a1 is discharged vertically downward. On the other hand, the pattern air supply path 65p is formed vertically downward along the outer wall 66p from the upper end portion of the tip portion 60p to below the position of the atomizing air supply port 63ap, and then a pattern air supply port 65ap is formed inwardly from the lower end portion of the pattern air supply path 65p. The side cross-sectional view of the tip portion 60p has a configuration with a downward concave portion. It can be seen that the air (a1, a2) directed vertically downwards to the coating target object is substantial in amount and therefore strong. Also, it can be seen that a spray direction of the coating material M and a direction of the air (a1, a2) are almost identical in direction. In other words, direct air to the coating target object is dominant.

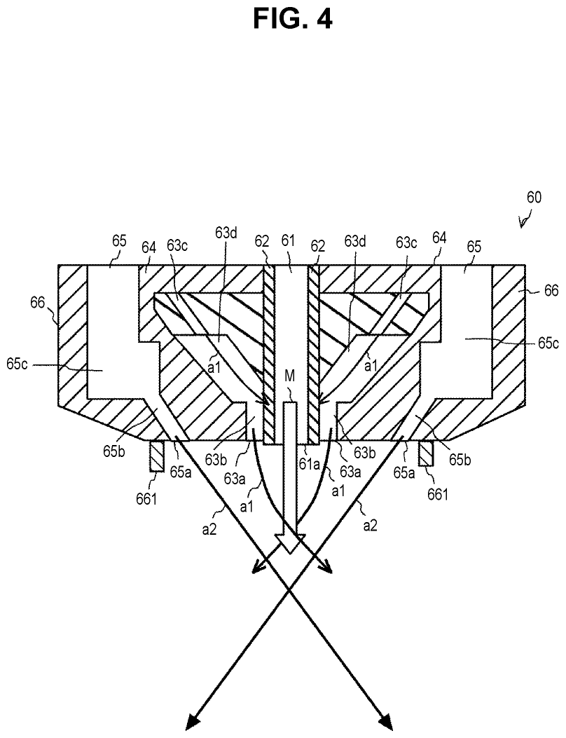

FIG. 4 is an enlarged view of the tip portion of the spray device according to the embodiment.

A path 63c of the atomizing air supply path 63 according to the embodiment is formed so as to twist (spiral) diagonally inward from the upper end portion of the tip portion 60, and then a path 63d having a wide width is formed to the vicinity of the coating material supply pipe 62. A path 63b of the atomizing air supply path 63 is formed vertically downward thereafter, but the atomizing air a1 is still spirally emitted. Therefore, the atomizing air a1 obliquely collides with the spray direction (vertically downward) of the coating material M to atomize the coating material M.

Further, a path 65c having a wide width of the pattern air supply path 65 according to the embodiment is formed vertically downward along the outer wall 66 from the upper end portion of the tip portion 60, and then a path 65b with a smaller diameter is formed in a spiral shape obliquely inward (that is, towards a supply direction of the coating material M). The pattern air supply port 65a has an elliptical shape as illustrated at the top of FIG. 2. The pattern air a2 collides (obliquely) with the atomized coating material M in the spray direction of the atomized coating material M and diffuses the atomized coating material M. As a result, as illustrated in the bottom of FIG. 2, a substantially circular and wide application area can be coated. Also, direct air to the coating target object can be reduced to improve the electrostatic effect.

In some embodiments, the path 63c designed to atomize air and the path 65b for pattern air may be twisted in a parallel direction or in different directions. Although the tip portion 60p has a substantially rectangular cross-sectional side view, the tip portion 60p is tapered at an outer peripheral edge portion of the downward concave portion.

In some embodiments, there may be a plurality of spray devices 6 provided for each type (for example, water-based, solvent-based, and the like) of coating material. The type of coating material can include coating material color, properties (for example, water-based, solvent-based, and the like), and the like.

According to the spray device and coating method described above, the direct air supply to the coating target object is reduced and the electrostatic effect is improved, thereby significantly improving the coating efficiency. In addition, since the size of the spray device is smaller than that of a bell-type coating machine, individual spray devices can be arranged for each type of coating material (for example, water-based, solvent-based, and the like).

The present disclosure is not limited to the embodiment described above, and can be modified as appropriate without departing from the scope of the disclosure.

What is claimed is:

1. A spray device that atomizes and applies coating material to a coating target object, the spray device comprising:
a tip portion provided with a coating material supply port to supply coating material, an atomizing air supply port to supply air designed to atomize the supplied coating material, a plurality of pattern air supply ports to supply pattern air designed to adjust a spray width of the supplied coating material onto the coating target object, and first twisted supply paths to each of the pattern air supply ports; and
a shielding plate that is provided adjacent to outside of the pattern air supply ports and protrudes from a lower surface of the tip portion toward the coating target object to prevent inflow of air outside an outer wall of the spray device, wherein:
the atomizing air supply port is provided adjacent to the coating material supply port;
the pattern air supply ports are provided to surround the coating material supply port and the atomizing air supply port; and
the first twisted supply paths are configured to supply the pattern air obliquely and spirally with respect to a supply direction of the coating material.

2. The spray device according to claim 1 wherein a plurality of second twisted supply paths spaced apart from each other and provided inside the spray device are configured to spirally supply atomizing air from the atomizing air supply port in the supply direction of the coating material.

3. The spray device according to claim 2 wherein the second twisted supply paths have a shape twisted obliquely inward from an upper portion of the tip portion.

4. The spray device according to claim 2 wherein a first twist direction of the first twisted supply paths to the pattern air supply ports and a second twist direction of the second twisted supply paths to the atomizing air supply port are directed to the same direction.

5. The spray device according to claim 2 wherein the tip portion includes a wide path which is connected to the second twisted supply paths and is wider than the second twisted supply path.

6. The spray device according to claim 1 wherein the atomizing air supply port is provided to surround the coating material supply port and has a circular ring shape.

7. The spray device according to claim 2 wherein the tip portion includes:
a wide path which is connected to the second twisted supply paths and is wider than the second twisted supply path;
a coating material supply path to supply the coating material, the coating material supply path being connected to the coating material supply port; and
a straight path that is connected to the wide path, extends in an axial direction of the coating material supply path, and has an annular cylindrical shape.

8. The spray device according to claim 1 wherein the tip portion includes a wide path that is wider than the first twisted supply path, extends from an upper portion of the tip portion in an axial direction of a coating material supply path to supply the coating material, and is connected to the first twisted supply path, the coating material supply path being connected to the coating material supply port.

9. The spray device according to claim 1 wherein the first twisted supply path is spirally formed towards a central axis of the tip portion.

10. The spray device according to claim 1 wherein the pattern air supply port has an elliptical shape.

11. A coating method using the spray device according to claim 1.
